(19) United States
(12) Patent Application Publication
(10) Pub. No.: US 2026/0135097 A1
(43) Pub. Date: May 14, 2026

(54) CATHODE FOR LITHIUM-ION SECONDARY BATTERY

(71) Applicant: TOYOTA JIDOSHA KABUSHIKI KAISHA, Toyota-shi (JP)

(72) Inventors: Ryosuke OHSAWA, Okazaki-shi (JP); Taku Kinoshita, Toyota-shi (JP); Yuji Mahara, Toyota-shi (JP)

(73) Assignee: TOYATA JIDOSHA KABUSHIKI KAISHA, Toyota-shi (JP)

(21) Appl. No.: 19/358,655

(22) Filed: Oct. 15, 2025

(30) Foreign Application Priority Data
Nov. 13, 2024 (JP) 2024-198137

(51) Int. Cl. H01M 4/525; H01M 4/36; H01M 10/0525; H01M 4/02

(52) U.S. Cl. CPC H01M 4/525; H01M 4/364; H01M 10/0525; H01M 2004/021; H01M 2004/028

(57) ABSTRACT

A cathode for a lithium-ion secondary battery includes a cathode active material layer. The cathode active material layer contains a cathode active material. The cathode active material contains single-crystal particles. One hundred single-crystal particles randomly sampled from a scanning electron microscope image of a cross-section of the cathode active material layer include at least one first particle including a recess and at least one second particle including a protrusion. The following relationships are satisfied: "0.01 ≤ d/D1 ≤ 0.56" and "0.01 ≤ h/D2 ≤ 0.58," where "d" represents the depth of the recess of the first particle, "D1" represents the diameter of the minimum circumscribed circle of the first particle, "h" represents the height of the protrusion of the second particle, and "D2" represents the diameter of the minimum circumscribed circle of the second particle.

### CROSS-REFERENCE TO RELATED APPLICATION

This application claims priority to Japanese Patent Application No. 2024-198137 filed on November 13, 2024. The disclosure of the above-identified application, including the specification, drawings, and claims, is incorporated by reference herein in its entirety.

### BACKGROUND

### 1. Technical Field

The present disclosure relates to cathodes for lithium-ion secondary batteries.

### 2. Description of Related Art

Japanese Unexamined Patent Application Publication No. 2023-036570 (JP 2023-036570 A) discloses a large grain aggregate ternary cathode material with single-crystal-like morphology.

### SUMMARY

Single-crystallization of cathode active materials has been proposed. Since single-crystal particles have, for example, a smaller specific surface area than polycrystalline particles, they are expected to improve cycle characteristics. However, there remains room for improvement in terms of initial resistance.

An object of the present disclosure is to reduce initial resistance.

1. A cathode for a lithium-ion secondary battery includes a cathode active material layer. The cathode active material layer contains a cathode active material. The cathode active material contains single-crystal particles. One hundred single-crystal particles randomly sampled from a scanning electron microscope image of a cross-section of the cathode active material layer include at least one first particle including a recess and at least one second particle including a protrusion. The following relationships are satisfied: "0.01 ≤ d/D1 ≤ 0.56" and "0.01 ≤ h/D2 ≤ 0.58," where "d" represents the depth of the recess of the first particle, "D1" represents the diameter of the minimum circumscribed circle of the first particle, "h" represents the height of the protrusion of the second particle, and "D2" represents the diameter of the minimum circumscribed circle of the second particle.

Single-crystal particles typically have a smooth surface. The single-crystal particles can be densely packed in the cathode active material layer. It is considered that gaps through which an electrolyte solution can diffuse are less likely to be formed between the single-crystal particles. As a result, the initial resistance may increase.

The cathode active material layer of the present disclosure contains single-crystal particles having specific shapes. That is, the cathode active material layer contains the first particle and the second particle. The recess of the first particle and the protrusion of the second particle can form, in the cathode active material layer, gaps through which the electrolyte solution can diffuse. Moreover, the recess and the protrusion each have an appropriate size relative to the size of the single-crystal particles. This can facilitate diffusion of the electrolyte solution. As a result, a reduction in initial resistance can be expected. Hereinafter, the "cathode for a lithium-ion secondary battery" may be simply referred to as "cathode."

2. The cathode according to "1" described above may include, for example, the following configuration. The randomly sampled one hundred single-crystal particles include at least one third particle including the recess and the protrusion.

One single-crystal particle may have both the recess and the protrusion.

3. The cathode according to "1" or "2" described above may include, for example, the following configuration. The cathode active material contains 50% or more by number of the single-crystal particles, with the remainder being polycrystalline particles.

The higher the number fraction of the single-crystal particles, the more likely it is that, for example, the cycle characteristics will be improved.

4. The cathode according to any one of "1" to "3" described above may include, for example, the following configuration. The cathode active material contains a lithium transition metal composite oxide.

5. The cathode according to any one of "1" to "4" described above may include, for example, the following configuration. The cathode active material has a composition represented by the following general formula: "LiₓNiₐCo_{b}Mn_{c}O_{y}." In the general formula, "x, a, b, c, and y" satisfy the following relationships: "0.1 ≤ x ≤ 1.5," "0.5 ≤ a ≤ 1.0," "0 ≤ b ≤ 0.3," "0 ≤ c ≤ 0.3," "a + b + c = 1.0," and "1.5 ≤ y ≤ 2.1."

Since the Ni composition ratio "a" is 0.5 or more, an increase in initial discharge capacity, for example, can be expected.

An embodiment of the present disclosure (hereinafter also referred to as "present embodiment") and an example of the present disclosure (hereinafter also referred to as "present example") will be described. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally intended that any configurations may be extracted from the embodiment and combined as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a cross-section of a first particle;

FIG. 2 is a conceptual diagram of a cross-section of a second particle;

FIG. 3 is a schematic cross-sectional view of a cathode for a lithium-ion secondary battery according to an embodiment;

FIG. 4 is a table showing experimental results;

FIG. 5 is a first temperature profile; and

FIG. 6 is a second temperature profile.

### DETAILED DESCRIPTION OF EMBODIMENTS

### Terms and Phrases

The terms "Comprise," "include," "have," and their variations are open-ended expressions. A configuration expressed in an open-ended manner may or may not include additional elements in addition to essential elements. The term "consist of" is a closed-ended expression. Even a configuration expressed in a closed-ended manner may include additional elements such as incidental impurities or elements irrelevant to the target technology. The term "substantially consist of" is a semi-closed-ended expression. In a configuration expressed in a semi-closed-ended manner, it is allowed to add elements that do not substantially affect the fundamental and novel characteristics of the target technology.

For example, the phrase "either or both of A and B" includes "A or B" and "A and B." The phrase "either or both of A and B" may also be written as "A and/or B."

Geometric terms should not be interpreted in their strict sense. Examples of the geometric terms include "parallel," "perpendicular," and "orthogonal." For example, the direction, angle, distance, etc. may be relatively displaced as long as substantially the same or similar functions are achieved. The geometric terms may include tolerances, errors, etc. such as those related to design, operations, and manufacturing. The dimensional relationships in each figure may not correspond to the actual dimensional relationships. The dimensional relationships in each figure may have been modified to facilitate the reader’s understanding. For example, the length, width, thickness, etc. may have been changed. Some components may also have been omitted.

Numerical values may be expressed in significant figures. Measured values may be the averages of multiple measurements, unless otherwise specified. The number of measurements may be three or more, five or more, or 10 or more. Typically, the larger the number of measurements, the higher the reliability of the average is expected to be. Measured values may be rounded based on the number of significant figures. Measured values may include errors such as those associated with the detection limits of measurement devices.

The devices, software, etc. used for measuring various values are merely examples. Devices etc. equivalent to those exemplified herein may be used. When an equivalent device is used, the measurement conditions may be adjusted in accordance with the device.

First and second particles may be observed in scanning electron microscope (SEM) images of a cross-section of a cathode active material layer. Hereinafter, SEM images of the cross-section of the cathode active material layer may be abbreviated as "cross-sectional SEM images." Five samples are taken from a cathode. The sampling points may be distributed across the entire cathode. The sampling points may be equally spaced apart from each other. For example, a smooth surface is formed on the sample by sectioning it with a cross-section polisher etc. Cross-sectional SEM images are obtained by observing the smooth surface by SEM. The imaging magnification can be adjusted according to the particle size. The imaging magnification may be, for example, 5,000× to 50,000×. One hundred single-crystal particles are randomly sampled from five cross-sectional SEM images. First and second particles are extracted from the 100 single-crystal particles.

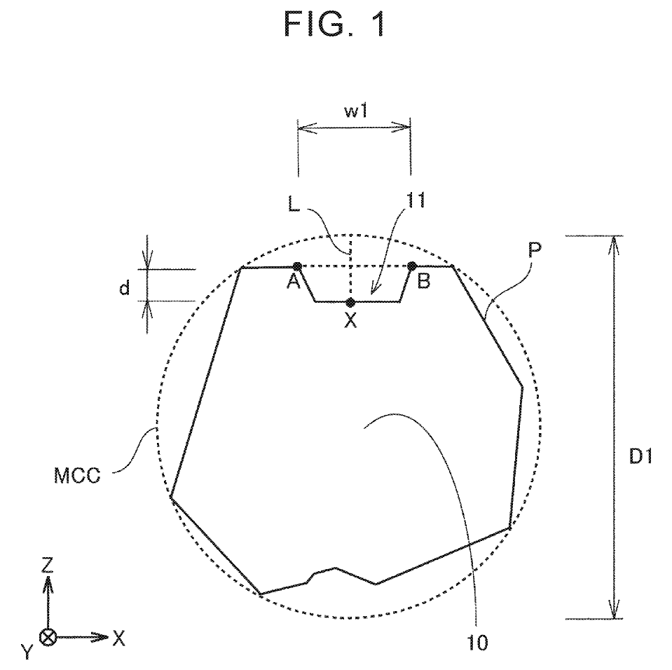

FIG. 1 is a conceptual diagram of a cross-section of a first particle. A first particle 10 includes a recess 11. The recess 11 indicates a portion where the contour line of the particle is recessed inward. The depth "d" of the recess 11 is determined by the following procedure. Various dimensional measurements and shape analyses of the cross-sectional SEM images may be performed using, for example, image processing software such as "ImageJ."

(1) The minimum circumscribed circle "MCC" for the contour line "P" of the particle is determined. The diameter of the MCC is the diameter "D1."

(2) A line segment "L" is drawn that extends from the circumference of the MCC toward the center of the MCC and reaches P.

(3) Of the intersection points of L and P, the point where L is the longest is considered to be the bottom point "X" of the recess.

(4) A double tangent line "T" having points of tangency "A," "B" on both sides of the bottom point is determined.

(5) The distance between T and X is considered to be the depth "d" of the recess. The length of the line segment "A–B" is considered to be the width "w1" of the recess.

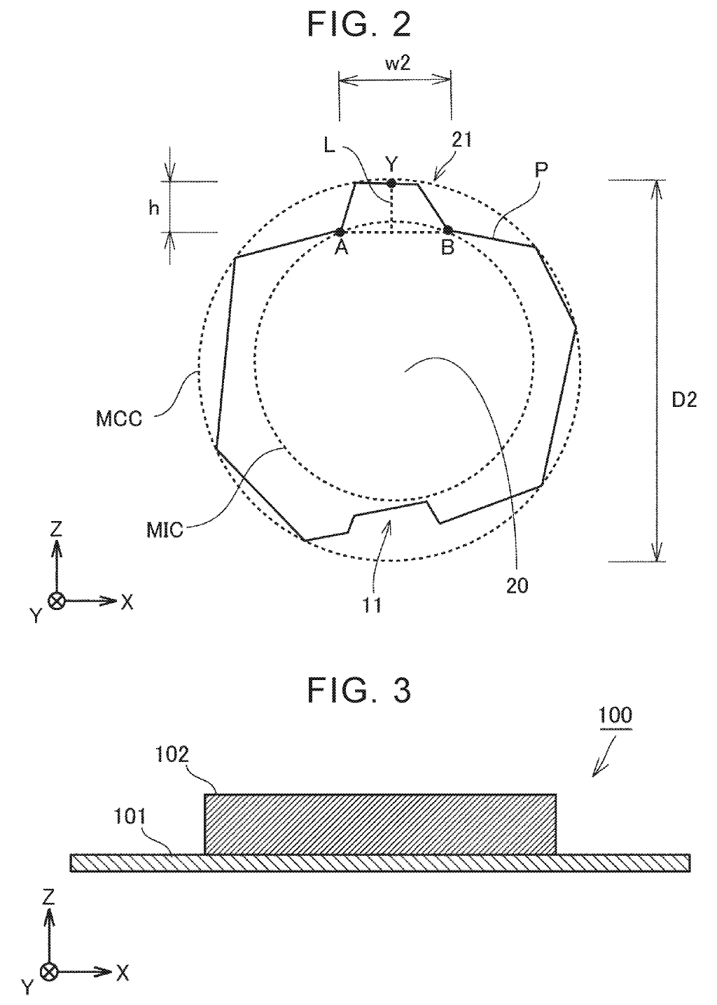

FIG. 2 is a conceptual diagram of a cross-section of a second particle. A second particle 20 includes a protrusion 21. The protrusion 21 indicates a portion where the contour line of the particle protrudes outward. The height "h" of the protrusion 21 is determined by the following procedure.

(1) The maximum circumscribed circle "MIC" for the contour line "P" of the particle is determined.

(2) A line segment "L" is drawn that extends radially from the circumference of the MIC and reaches P.

(3) Of the intersection points of L and P, the point where L is the longest is considered to be the top point "Y" of the protrusion.

(4) Of the points of tangency between MIC and P, the points "A," "B" closest to the top point "Y" are determined.

(5) The distance between the line segment "A–B" and the top point "Y" is considered to be the height "h" of the protrusion. The length of the line segment "A–B" is considered to be the width "w2" of the protrusion.

(6) The MCC for P is determined. The diameter of the MCC is the diameter "D2."

The term "single-crystal particle" refers to the smallest unit of a particle that is recognized as a solid particle that cannot be divided any further. A single-crystal particle does not appear to have particle boundaries in cross-sectional SEM images. A single-crystal particle is also referred to as "primary particle." An aggregate of two or more primary particles is regarded as a "polycrystalline particle." One hundred particles are randomly sampled from the above cross-sectional SEM images. The number fraction of single-crystal particles is determined by counting the number of single-crystal particles among the 100 particles.

The "maximum Feret diameter" refers to the length of the long side of the minimum bounding rectangle (MBR) for the contour line of a particle in an SEM image. When the MBR is a square, the length of one side of the MBR is considered to be the length of the long side. The average value of the 100 particles is used as the maximum Feret diameter.

The chemical composition of the cathode active material may be measured by inductively coupled plasma atomic emission spectroscopy (ICP-AES). A sample solution is prepared by dissolving 0.1 g of a sample (cathode active material) in a mixed acid (10 ml) of hydrochloric acid and sulfuric acid. The sample solution is diluted to an appropriate concentration using a volumetric flask. After the dilution, compositional analysis is performed using an ICP-AES device. For example, a product such as "PS3520UVDDII (manufactured by Hitachi High-Tech Corporation)" may be used.

FIG. 3 is a schematic cross-sectional view of a cathode for a lithium-ion secondary battery according to the embodiment. A cathode 100 is for use in a lithium-ion secondary battery. The lithium-ion battery may be a liquid battery or an all-solid-state battery. The lithium-ion secondary battery may have any structure. The lithium-ion secondary battery may have, for example, a wound or stacked power generating element. The lithium-ion secondary battery may have, for example, a unipolar structure or a bipolar structure.

The cathode 100 may be, for example, in the form of a sheet. The cathode 100 includes a cathode active material layer 102. The cathode 100 may further include a cathode substrate 101. The cathode substrate 101 may support the cathode active material layer 102. The cathode active material layer 102 may be formed on one side of the cathode substrate 101. The cathode active material layer 102 may be formed on both sides of the cathode substrate 101. The cathode substrate 101 may serve as a current collector. The cathode substrate 101 may include, for example, aluminum (Al) foil etc. The cathode substrate 101 may have a thickness of, for example, 5 μm to 50 μm.

The cathode active material layer 102 may have a thickness of, for example, 10 μm to 1000 μm. The cathode active material layer 102 contains a cathode active material. The cathode active material layer 102 may further contain, for example, an electrically conductive material, a binder, etc. in addition to the cathode active material. The cathode active material layer may contain, for example, 0.1% to 10% by mass of an optional component (such as an additive), 0.1% to 10% by mass of the binder, and 0.1% to 10% by mass of the electrically conductive material, with the remainder being the cathode active material.

The cathode active material contains single-crystal particles. The cathode active material may further contain polycrystalline particles. The polycrystalline particles may have substantially the same composition and crystal structure as the single-crystal particles. The cathode active material may contain, for example, 50% or more by number of the single-crystal particles, with the remainder being the polycrystalline particles. Since the number fraction of the single-crystal particles is 50% or more, improvement in cycle characteristics, for example, can be expected. The number fraction of the single-crystal particles may be, for example, 60% or more, 70% or more, 80% or more, 90% or more, or 95% or more. The number fraction of the single-crystal particles may be, for example, 95% or less, 90% or less, 80% or less, 70% or less, or 60% or less.

In the cross-sectional SEM images of the cathode active material layer 102, the maximum Feret diameter of the single-crystal particles may be, for example, 0.1 μm or more, 0.5 μm or more, 1 μm or more, 2 μm or more, 3 μm or more, 4 μm or more, 5 μm or more, 6 μm or more, 7 μm or more, 8 μm or more, or 9 μm or more. The maximum Feret diameter of the single-crystal particles may be, for example, 10 μm or less, 9 μm or less, 8 μm or less, 7 μm or less, 6 μm or less, 5 μm or less, 4 μm or less, 3 μm or less, 2 μm or less, or 1 μm or less.

One hundred single-crystal particles randomly sampled from the cross-sectional SEM images of the cathode active material layer 102 include at least one first particle 10 and at least one second particle 20. The first particle 10 includes a recess 11. The second particle 20 includes a protrusion 21. Since the cathode active material layer 12 contains both the first particle 10 and the second particle 20, diffusion of the electrolyte solution can be facilitated.

The recess 11 included in the first particle 10 has a specific depth. In other words, the following relationship is satisfied: "0.01 ≤ d/D1 ≤ 0.56." The ratio "d/D1" of the depth of the recess 11 to the particle diameter may be, for example, 0.02 or more, 0.03 or more, 0.04 or more, 0.05 or more, 0.10 or more, 0.20 or more, 0.30 or more, 0.40 or more, 0.45 or more, 0.50 or more, or 0.56 or more. The ratio "d/D1" of the depth of the recess 11 to the particle diameter may be, for example, 0.70 or less, 0.60 or less, 0.56 or less, 0.50 or less, 0.45 or less, 0.40 or less, 0.30 or less, 0.20 or less, 0.10 or less, 0.05 or less, 0.04 or less, 0.03 or less, or 0.02 or less.

The recess 11 may have a specific width. For example, the following relationship may be satisfied: "w1/D1 ≤ 0.50." The ratio "w1/D1" of the width of the recess 11 to the particle diameter may be, for example, 0.40 or less, 0.30 or less, 0.20 or less, 0.10 or less, or 0.05 or less. The ratio "w1/D1" of the width of the recess 11 to the particle diameter may be, for example, 0.01 or more, 0.03 or more, 0.05 or more, 0.10 or more, 0.20 or more, 0.30 or more, or 0.40 or more.

The first particle 10 may include a single recess 11. The first particle 10 may include a plurality of recesses 11. The number of recesses 11 included in the first particle 10 may be, for example, one or more, two or more, three or more, four or more, or five or more. The number of recesses 11 included in the first particle 10 may be, for example, 10 or less, nine or less, eight or less, seven or less, six or less, five or less, four or less, three or less, or two or less. When the first particle 10 includes a plurality of recesses 11, the values of the depth "d" and the width "w" are determined from the deepest recess 11.

The protrusion 21 included in the second particle 20 have a specific height. In other words, the following relationship is satisfied: "0.01 ≤ h/D2 ≤ 0.58." The ratio "h/D2" of the height of the protrusion 21 to the particle diameter may be, for example, 0.02 or more, 0.03 or more, 0.04 or more, 0.05 or more, 0.10 or more, 0.20 or more, 0.30 or more, 0.40 or more, 0.50 or more, 0.52 or more, 0.58 or more, or 0.60 or more. The ratio "h/D2" of the height of the protrusion 21 to the particle diameter may be, for example, 0.70 or less, 0.60 or less, 0.58 or less, 0.52 or less, 0.50 or less, 0.40 or less, 0.30 or less, 0.20 or less, 0.10 or less, 0.05 or less, 0.04 or less, 0.03 or less, or 0.02 or less.

The protrusion 21 may have a specific width. For example, the following relationship may be satisfied: "w2/D1 ≤ 0.50." The ratio "w2/D2" of the width of the protrusion 21 to the particle diameter may be, for example, 0.40 or less, 0.30 or less, 0.20 or less, 0.10 or less, or 0.05 or less. The ratio "w2/D2" of the width of the protrusion 21 to the particle diameter may be, for example, 0.01 or more, 0.03 or more, 0.05 or more, 0.10 or more, 0.20 or more, 0.30 or more, or 0.40 or more.

The number of first particles 10 among the 100 single-crystal particles may be, for example, two or more, five or more, 10 or more, 20 or more, 30 or more, 40 or more, 50 or more, 60 or more, 70 or more, 80 or more, or 90 or more. The number of first particles 10 among in the 100 single-crystal particles may be, for example, 90 or less, 80 or less, 70 or less, 60 or less, 50 or less, 40 or less, 30 or less, 20 or less, 10 or less, five or less, or two or less.

The number of second particles 20 among the 100 single-crystal particles may be, for example, two or more, five or more, 10 or more, 20 or more, 30 or more, 40 or more, 50 or more, 60 or more, 70 or more, 80 or more, or 90 or more. The number of second particles 20 among the 100 single-crystal particles may be, for example, 90 or less, 80 or less, 70 or less, 60 or less, 50 or less, 40 or less, 30 or less, 20 or less, 10 or less, five or less, or two or less.

The randomly sampled 100 single-crystal particles may include a third particle. The third particle includes both a recess 11 and a protrusion 21 described above. The number of third particles among the 100 single-crystal particles may be, for example, two or more, five or more, 10 or more, 20 or more, 30 or more, 40 or more, 50 or more, 60 or more, 70 or more, 80 or more, or 90 or more. The number of third particles among the 100 single-crystal particles may be, for example, 90 or less, 80 or less, 70 or less, 60 or less, 50 or less, 40 or less, 30 or less, 20 or less, 10 or less, five or less, or two or less. The second particle 20 in FIG. 2 is also a third particle that includes both a recess 11 and a protrusion 21.

The cathode active material may include, for example, a lithium transition metal composite oxide. The cathode active material may have a crystal structure belonging to space group R-3m. This crystal structure is also referred to as "layered structure." The crystal structure can be identified by an X-ray diffraction (XRD) pattern. The lithium transition metal composite oxide contains Li, transition metals, and oxygen.

The cathode active material may have a composition represented by, for example, the following general formula: "LiₓNiₐCo_{b}Mn_{c}O_{y}." In the general formula, the Li composition ratio "x" may satisfy, for example, the following relationship: "0.1 ≤ x ≤ 1.5." The Li composition ratio "x" may be, for example, 0.4 or more, 0.6 or more, 0.8 or more, 1.0 or more, 1.2 or more, or 1.4 or more. The Li composition ratio "x" may be, for example, 1.4 or less, or 1.2 or less.

In the above general formula, the O composition ratio "y" may satisfy, for example, the following relationship: "1.5 ≤ y ≤ 2.1." The O composition ratio "y" may be, for example, 1.6 or more, 1.7 or more, 1.8 or more, 1.9 or more, or 2.0 or more. The O composition ratio "y" may be, for example, 2.0 or less, 1.9 or less, 1.8 or less, 1.7 or less, or 1.6 or less.

In the above general formula, the Ni composition ratio "a", the Co composition ratio "b," and the Mn composition ratio "c" may satisfy the following relationship: "a + b + c = 1.0." The Ni composition ratio "a" may satisfy, for example, the following relationship: "0.5 ≤ a ≤ 1.0." The Ni composition ratio "a" may be, for example, 0.6 or more, 0.7 or more, 0.8 or more, or 0.9 or more. The Ni composition ratio "a" may be, for example, 0.9 or less, 0.8 or less, 0.7 or less, or 0.6 or less.

In the above general formula, the Co composition ratio "b" may satisfy, for example, the following relationship: "0 ≤ b ≤ 0.3." The Co composition ratio "b" may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Co composition ratio "b" may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, the Mn composition ratio "c" may satisfy, for example, the following relationship: "0 ≤ c ≤ 0.3." The Mn composition ratio "c" may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Mn composition ratio "c" may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, all or part of Mn may be substituted with Al etc. That is, the lithium transition metal composite oxide may have a composition represented by, for example, the following general formula: "LiₓNiₐCo_{b}Al_{c}O_{y}." The range of the Al composition ratio "c" is the same as that of the Mn composition ratio "c" described above.

Any dopant may be added to the lithium transition metal composite oxide. The dopant herein refers to an element other than Li, Ni, Co, Mn, and O. The dopant may include, for example, at least one selected from the group consisting of Zr, Mo, W, Mg, Ca, Na, Fe, Cr, Zn, Si, Sn, Al, and Ag. The composition ratio of the dopant may be, for example, 0.005 or more, 0.01 or more, 0.02 or more, 0.03 or more, or 0.04 or more. The composition ratio of the dopant may be, for example, 0.05 or less, 0.04 or less, 0.03 or less, 0.02 or less, or 0.01 or less.

### Sample Fabrication

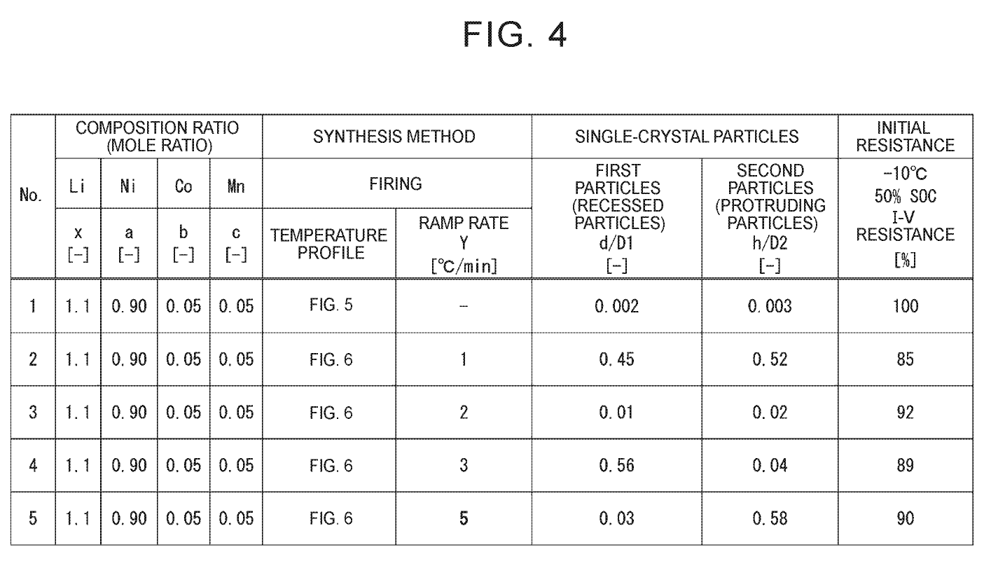

FIG. 4 is a table showing experimental results. Cathodes No. 1 to No. 5 were produced by the following procedure.

### Precursor Preparation

A raw material solution is formed by dissolving NiSO₄, CoSO₄, and MnSO₄ in deionized water. In the raw material solution, the molar ratio of Ni, Co, and Mn is "Ni/Co/Mn = 90/5/5." The solute concentration in the raw material solution is 30% (by mass).

Aqueous ammonia is added to a reaction vessel. While being stirred by a stirrer, the reaction vessel is purged with nitrogen. NaOH is also added to the reaction vessel to form an alkaline reaction solution.

The raw material solution and aqueous ammonia are added dropwise to the reaction solution while maintaining the pH of the reaction solution within a certain range, thereby forming a precipitate (metal hydroxide). The reaction solution is filtered to recover the metal hydroxide. A dispersion is formed by dispersing the metal hydroxide in deionized water. The dispersion is thoroughly stirred with a spatula. That is, the metal hydroxide is washed with water. After the washing, the dispersion is filtered to recover the metal hydroxide. The metal hydroxide is dried at 120°C for 16 hours to form a dried material.

### Addition of Li Source

The dry material (metal hydroxide) and lithium compounds (LiOH, Li₂CO₃) are mixed in a mortar with a pestle to form a mixture. By adding an excess amount of Li in terms of moles relative to the total amount of the transition metals, a molten salt is formed during firing. As a result, a lithium transition metal composite oxide can be crystallized into single crystals. That is, the number fraction of single-crystal particles may become 50% or more. The mole ratio of Li to the total amount of the transition metals is, for example, 1.5 or more.

### Firing

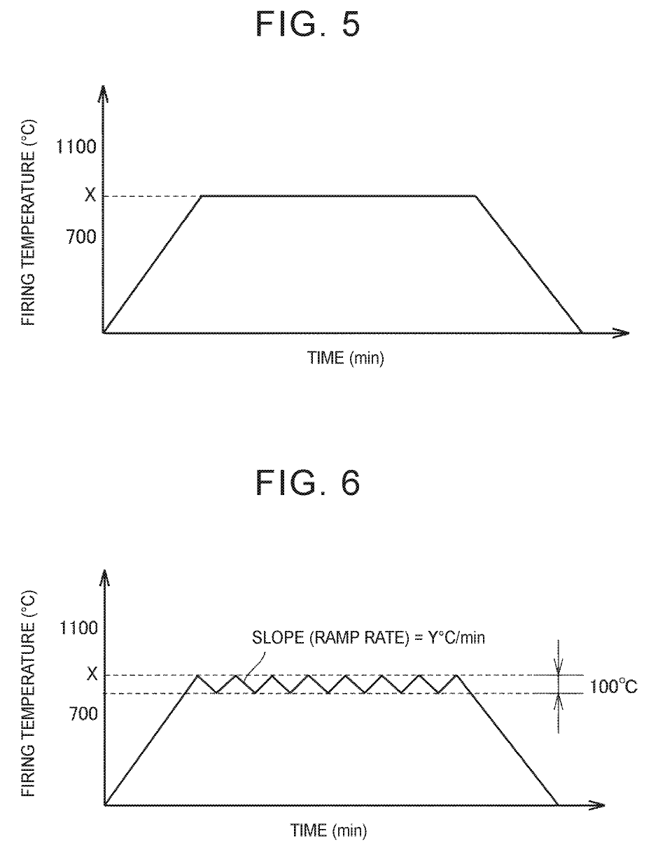

The mixture is fired (heat-treated) in a firing furnace (e.g., a muffle furnace) to synthesize a lithium transition metal composite oxide. The firing atmosphere is an oxygen atmosphere. FIG. 5 is a first temperature profile. In No. 1, the firing is performed according to the first temperature profile. The furnace temperature is raised to X°C that is within the range of 700°C to 1100°C. The firing temperature is maintained substantially at X°C for 10 hours. After the 10 hours, the furnace temperature is cooled down to room temperature.

FIG. 6 is a second temperature profile. In No. 2 to No. 5, the firing is performed according to the second temperature profile. The furnace temperature is raised to X°C that is within the range of 700°C to 1100°C. The temperature is reduced to X − 100°C at a rate of Y. Subsequently, the temperature is increased to X°C at a rate of Y. The cooling and heating rate "Y" is also referred to as "ramp rate." The ramp rate "Y" for each sample is shown in the "ramp rate" column in the table of FIG. 4. Thereafter, cooling and heating are alternately repeated for 10 hours. After the 10 hours, the furnace temperature is cooled down to room temperature.

After the firing, the particle size of the lithium transition metal composite oxide is adjusted using a pulverizer such as a jet mill. A cathode active material is thus produced.

### Cathode Fabrication

A slurry is formed by mixing the cathode active material, an electrically conductive material (acetylene black), a binder (polyvinylidene fluoride), and a dispersion medium. A cathode is produced by coating a surface of a substrate (Al film) with the slurry. A film applicator (with a film thickness control function) manufactured by Allgood Co., Ltd. is used as a coating device. After the slurry coating, the film is dried at 80°C for five minutes. Cross-sectional SEM images of the cathode are obtained. The presence or absence of first particles (recessed particles) and second particles (protruding particles), the depths "d" of the recesses, the heights "h" of the protrusions, and the diameters "D1, D2" of the particles are measured.

### Measurement of Initial Resistance

The initial resistance was measured by the following procedure.

A laminated cell is fabricated. The laminated cell has the following configuration.

Exterior casing: pouch made of an Al laminated film

Power generation element: stacked type (single layer)

Cathode: cathode active material/electrically conductive material/binder = 88/10/2 (mass ratio)

Anode: anode active material (natural graphite), CMC, SBR

Electrolyte: LiPF₆ (1 mol/L), EC/DMC/EMC = 3/4/3 (volume ratio)

The laminated cell is sandwiched between two stainless steel plates, thereby applying a predetermined pressure to the power generation element. The state of charge (SOC) of the laminated cell is adjusted to 50%. The I-V resistance is measured under a temperature environment of −10°C. The values shown in the "initial resistance" column in the table of FIG. 4 are relative values, with the initial resistance value of No. 1 being set as 100%.

### Experimental Results

As shown in FIG. 4, the initial resistance tends to decrease when the following relationships are satisfied: "0.01 ≤ d/D1 ≤ 0.56" and "0.01 ≤ h/D2 ≤ 0.58."

What is claimed is:

1. A cathode for a lithium-ion secondary battery, the cathode comprising a cathode active material layer, wherein:
the cathode active material layer contains a cathode active material;
the cathode active material contains single-crystal particles;
one hundred single-crystal particles randomly sampled from a scanning electron microscope image of a cross-section of the cathode active material layer include at least one first particle including a recess and at least one second particle including a protrusion; and
the following relationships are satisfied:
0.01 ≤ d/D1 ≤ 0.56, and
0.01 ≤ h/D2 ≤ 0.58,
where d represents a depth of the recess of the first particle,
D1 represents a diameter of a minimum circumscribed circle of the first particle,
h represents a height of the protrusion of the second particle, and
D2 represents a diameter of a minimum circumscribed circle of the second particle.

2. The cathode according to claim 1, wherein the randomly sampled one hundred single-crystal particles include at least one third particle including the recess and the protrusion.

3. The cathode according to claim 1, wherein the cathode active material contains 50% or more by number of the single-crystal particles, with a remainder being polycrystalline particles.

4. The cathode according to claim 1, wherein the cathode active material contains a lithium transition metal composite oxide.

5. The cathode according to claim 4, wherein the cathode active material has a composition represented by the following general formula:
LiₓNiₐCo_{b}Mn_{c}O_{y}
where x, a, b, c, and y satisfy the following relationships: 0.1 ≤ x ≤ 1.5, 0.5 ≤ a ≤ 1.0, 0 ≤ b ≤ 0.3, 0 ≤ c ≤ 0.3, a + b + c = 1.0, and 1.5 ≤ y ≤ 2.1.
